(19) United States
(12) Patent Application Publication
(10) Pub. No.: US 2017/0282316 A1
(43) Pub. Date: Oct. 5, 2017

(54) GRIPPING DEVICE FOR A PROCESSING TOOL, STORAGE SYSTEM AND METHOD

(71) Applicant: HOMAG GMBH, SCHOPFLOCH (DE)

(72) Inventors: Volker Schmieder, Mossingen (DE); Marco Matt, Wittlensweiler (DE)

(73) Assignee: HOMAG GMBH, SCHOPFLOCH (DE)

(21) Appl. No.: 15/512,663

(22) PCT Filed: Sep. 3, 2015
(86) PCT No.: PCT/EP2015/070127

§ 371 Date: Mar. 20, 2017

(30) Foreign Application Priority Data
Sep. 19, 2014 (DE) 102014218899.7

(51) Int. Cl. B23Q 3/155

(52) U.S. Cl. CPC B23Q 3/1554; B23Q 3/15539; B23Q 2003/155407; B23Q 2003/155411

(57) ABSTRACT

Disclosed is a gripping system for receiving a processing tool, and to a storage system. These processing tools are used in processing machines or centres in the woodworking industry. Also disclosed is a processing machine with the above-mentioned storage system. This processing machine is used for processing elongate pieces of wood.

### TECHNICAL FIELD

The present invention relates to a gripping device for holding a cutting tool and a storage system. Such cutting tools are used, for example, in machine tools and machining centers of the woodworking industry. The present invention further relates to a machine tool having the aforesaid storage system. Such a machine tool is used in particular for machining elongated pieces of wood.

### PRIOR ART

A wide variety of cutting tools are generally used in the production of wooden window scantlings because different profiles need to be created on these workpieces. In turn this means that a relatively large number of cutting tools or cutting units (hereafter also referred to as “tools”) have to be kept available and must be inserted into a machine tool as required.

In the prior art, various measures are disclosed for storing tools, and there is a requirement to optimize the tool change times and thus to carry out the preparation time for providing a tool at the same time as machining a workpiece. For this reason, a plurality of converters are usually used between the tool magazine and the tool change spindle.

Disk-type changers and chain-type changers are well-known as tool magazines. Disk-type changers require a relatively large amount of space due to their size and, while this is not the case with chain-type changers, the manufacturing costs for the chains of the chain-type changer are comparatively high. Depending on the specific requirement of a machine tool, a decision therefore has to be made as to whether a disk-type changer or a chain-type changer will be used.

For example, DE 10 2012 201 776 A1 is known which shows a disk-type changer for holding cutting tools and/or cutting units for a machining device. The disk-type changer (magazine) comprises a first holding device having a plurality of first holders for cutting tools and/or cutting units, these holders being arranged on a first circumference. In addition, a second holding device with a plurality of second holders is provided, the second holders being arranged on a second circumference which is smaller than the first circumference. The first and second holding devices are arranged in such a manner that the second circumference lies inside the first circumference.

EP 2 371 481 A1 which shows a tool magazine is also known. During a tool change, a spindle unit is moved into a transfer position and a gripping element of an arm carries out a tool transfer. A slide which removes a tool from the tool magazine and transfers it to a gripping device is used to remove a tool from the tool magazine. The gripping device in turn supplies the relevant tool to the spindle unit.

### SUBJECT MATTER OF THE INVENTION

The aim of the present invention is to provide a gripping device with which it is easier and faster to change a cutting tool or cutting unit (“tool”). In addition, according to the present invention, the intention is to design a compact storage system for cutting tools.

One idea of the present invention is to remove tools from a tool store/tool magazine and to insert them directly into a holder of a machining spindle. Accordingly, the tool is picked up by a gripping device in such a manner that the region (HSK taper) provided for fixing the tool in a holder of a machining spindle is exposed.

Claim 1 provides a gripping device which achieves at least one or all of the above-mentioned aims. The same applies to claim 9 which provides a storage system, and claim 15 which relates to a method. The features of the dependent claims relate to further preferred embodiments which can each be combined with one of the independent claims or with each other.

Very fast tool change cycles can be implemented with the gripping device according to the invention. The gripping device can also prepare a tool change parallel to machining which results in a reduction of the non-productive times. In addition, it is possible due to the gripping device to shift from a stationary tool magazine or linear changer to a tool magazine, for example a disk-type changer, which moves with a tool change spindle. The gripping device can also be designed as a shuttle and thus supply tools from a simple, stationary tool magazine.

A storage system with a tool magazine which has a plurality of levels has the advantage that a large number of tools can be stored compactly and inexpensively. If necessary, different tools can also be picked from different tool magazines. It is possible to reduce the non-productive times in combination with the gripping device previously mentioned.

The present invention provides a gripping device for picking a tool from a tool magazine and for transferring said tool to a machining unit, in particular a machining spindle. The gripping device comprises: a basic body and a gripping mechanism joined to said basic body, the gripping mechanism being configured to create a force-fit connection to an outer circumference of a tool holder. In addition to the force-fit connection, a form-fit connection can also be created. The outer circumference of a tool holder of the tool is preferably designed to be cylindrical and preferably adjoins the HSK taper.

In this way it is possible for an HSK taper of a tool to be exposed and the tool can thus be inserted directly into a holder of a machining unit, in particular a machining spindle. The outer circumference of a tool holder is essentially cylindrical and in particular comprises an HSK gripper groove which, among other things, is provided for holding the tool in a tool magazine, in particular in a tool clamp.

In one embodiment, the gripping mechanism has two gripper jaws which in sections comprise a gripping portion for gripping the outer circumference of a tool holder. The gripper jaws are preferably each pivotable relative to the basic body by means of a rotary axis, or the gripper jaws can be moved towards each other in parallel. According to a modification, the gripper jaws can have a common rotary axis.

The gripper jaws can have a first cut-out for a support pin and/or an alignment region for a entrainer pin which is preferably designed as a cut-out. The alignment region is preferably provided on an end portion of the gripper jaws. It is possible to align the tool via the entrainer pin.

The gripper jaws have a reduced thickness in the region of an end portion. In this way, a collision with the holding disk (disk-type changer) or holding devices of a chain-type changer can be prevented.

In one embodiment, the gripping mechanism can have a support element which is fixed to the basic body or is formed integrally with the basic body, said support element having in sections a protrusion. This protrusion is preferably formed in such a manner that it may intrude into an HSK gripper groove and in this way prevents the tool from tilting. In particular, the protrusion is formed in sections along a circumference and intrudes into an HSK gripper groove in a circumferential portion or the protrusion is a pin (pressure element) which intrudes into a hole on the tool. The protrusion can be rigid or flexible.

In a further aspect, a possibly horizontal hole can be provided in the tool holder and the tool can be moved via a pin that is inserted or pushed through.

The present invention further relates to a storage system for cutting tools, comprising a tool magazine with a plurality of levels, in particular a disk-type tool magazine with a plurality of holding disks, and at least one gripping device which is movable relative to the tool magazine along a preferred vertical guide. Due to the arrangement of a plurality of levels, the tool magazine and therefore also the storage system can be of a very compact design. Thus it is possible to integrate the storage system in a machine tool. Due to the individual features described above, the said gripping device can be constructed in particular according to claim 1.

A tool is held on or in a tool clamp of the tool magazine, the tool clamp preferably being provided on a holding disk. As a result, the tool is held in the tool magazine, or is held clamped.

The gripping device can further be configured to create a force-fit connection or a force-fit and form-fit connection to an outer circumference of a tool holder of a tool. In this version, the tool can be released from a tool clamp by providing a force-fit connection.

The levels of the tool magazine, preferably the plurality of holding disks of the disk-type tool magazine, are preferably independently movable, in particular rotatable. Thus, for example, it is possible to manually remove a tool while simultaneously operating a different level of the tool magazine.

In a further version, a rotating mechanism is provided which is configured to rotate the at least one, preferably two, gripping devices about a vertical axis. In this way, the non-productive times can be further shortened. The rotating mechanism is preferably mounted on a second slide movable in the horizontal direction.

Moreover, a machine tool with a storage system is provided. The storage system is integrated in the machine tool and comprises a tool magazine with a plurality of levels, in particular a disk-type tool magazine with a plurality of holding disks.

A method for transferring a tool to a machining unit, in particular a machining spindle, comprises the following steps: At least force-fit or force- and form-fit gripping of a tool with a gripping device on an outer circumference of a tool holder of the tool, removal of the tool from a tool magazine, in particular from a tool clamp of a holding disk, and transfer of the tool from the gripping device into a holder of a machining unit, in particular a machining spindle.

In this way, the tool can be transferred directly into the machining unit from the tool magazine by means of the gripping device, especially as the HSK taper protrudes relative to said gripping device, once the gripping device creates a force-fit or force- and form-fit connection to the tool on a circumference of the tool holder.

The method is preferably carried out using the previously described gripping device or machine tool and the previously described storage system.

### BRIEF DESCRIPTION OF THE DRAWINGS

FIG. 1 is a perspective view of a gripping device according to an embodiment of the present invention.

FIG. 2 shows the gripping device illustrated in FIG. 1 before picking up a tool.

FIG. 3 is a view corresponding to FIG. 2 seen from a different viewing direction.

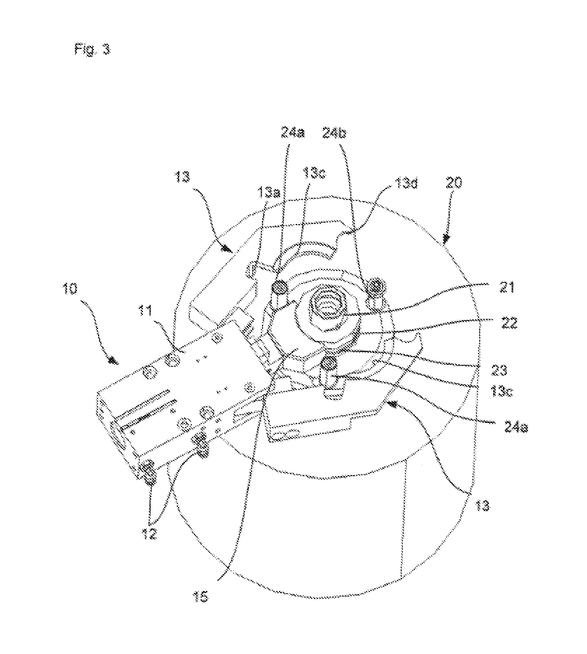

FIG. 4 shows a tool gripped with the gripping device before the transfer into a machining spindle.

FIG. 5 shows a tool gripped with the gripping device.

FIG. 6 shows the gripping device during the transfer of a tool from a holding disk of a tool magazine.

FIG. 7 shows a tool magazine with a plurality of adjacently arranged, disk-shaped holding disks.

FIG. 8 shows a plurality of adjacently arranged tool magazines with a plurality of holding disks.

### DETAILED DESCRIPTION OF THE PREFERRED EMBODIMENTS

Embodiments of the present invention will be described in detail in the following. Further modifications of certain individual features referred to in this context can each be combined with one another to form new embodiments.

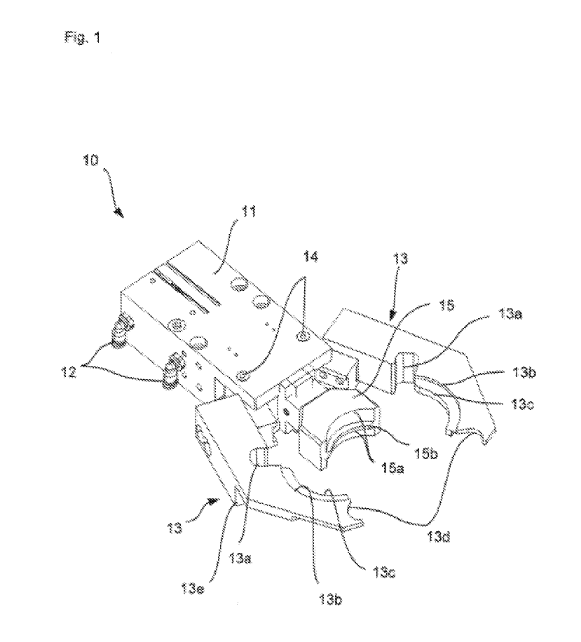

FIG. 1 shows an embodiment of a gripping device 10 according to the invention. The gripping device 10 comprises a basic body 11 which is provided with compressed air connections 12. A medium for the operation of gripper jaws 13 is supplied through the compressed air connections 12 as a result of which the gripper jaws 13 of the gripping device 10 can be opened and closed pneumatically.

In the present embodiment, the basic body 11 comprises compressed air connections 12 which operate a pneumatic mechanism for pivoting the gripper jaws 13. In an alternative embodiment, the gripper jaws 13 can also be operated hydraulically. It is also possible in further versions to provide an electric motor on the basic body 11 which is used for operating the gripper jaws 13.

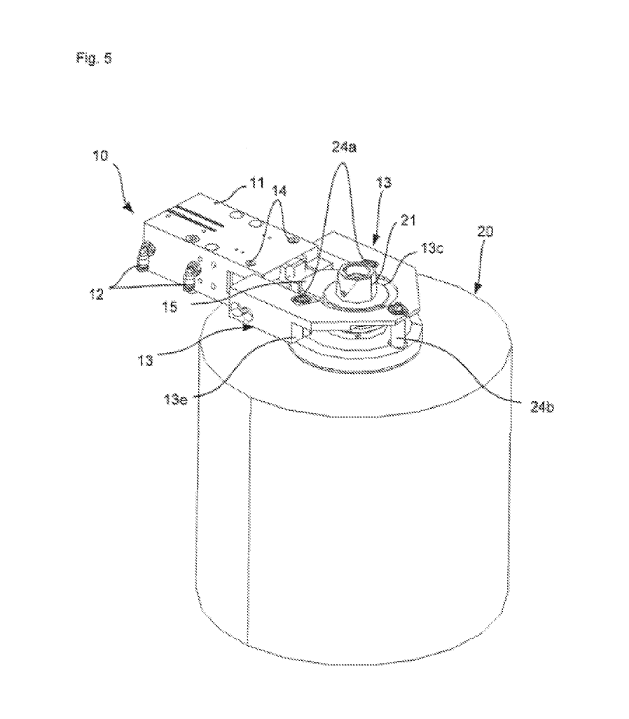

The gripper jaws 13 are each connected to the basic body 11 by means of a pivot joint 14 and in this way are pivotable between an open position (FIG. 1) and a closed position (FIG. 5).

While in the present embodiment one pivot joint 14 is provided for each of the gripper jaws 13, according to a modification of the present embodiment the gripper jaws can also be attached to a common pivot joint with a common rotary axis. The gripper jaws can also be designed as parallel grippers.

A support element 15 which has a contact surface 15a for a tool holder of a tool 20 is attached to the basic body 11 between the gripper jaws 13. The contact surface 15a has a radius such that said surface can rest against an outer circumference of a tool holder of the tool 20. In addition, in the region of the contact surface 15a, a protrusion 15b is provided which intrudes into an HSK gripper groove 23 of the tool 20 when a tool 20 is picked up.

Although the support element 15 in the present embodiment is formed as a separate component from the basic body, said support element 15 can also be formed integrally with the basic body 11. The support element 15 is used to support the tool 20 picked up with the gripping device 10 and secure it against tilting.

Each of the gripper jaws 13 comprises a first cut-out 13a which is dimensioned according to a support pin 24a of the tool 20 such that the support pin 24a can be inserted into the cut-out 13a.

Each gripper jaw 13 further comprises a gripping portion 13c for a circumference of the tool holder 22 of a tool 20. A shoulder 13a is also provided in this region. The radius of the gripping portion 13c corresponds to that of the contact surface 15a of the support element 15.

A second cut-out 13d, which is dimensioned according to approximately half the circumference of an entrainer pin 24b of a tool 20, is provided on each of the gripper jaws 13 in an end region of said gripper jaws 13 directed away from the basic body 11. In this case, the second cut-out 13d of the gripper jaws 13 cooperates with that of the second gripper jaw 13 to enclose the corresponding entrainer pin 24b at least in sections in the closed state of the gripping device 10. At the same time, the tips of the gripper jaws 13 do not touch in the present embodiment.

Each gripper jaw 13 has a reduced thickness starting from the first cut-out 13a towards the end region. In this manner, this region of the gripper jaws 13 can be guided via a holding disk 101 of a tool magazine. By contrast, the portion of the gripper jaws 13 directed towards the basic body 11 has a greater thickness in order to impart greater stability to the gripper jaws 13 in the attachment region to the basic body 11 (pivot joints 14). Due to the described change in thickness of the gripper jaws 13, a step 13e is formed in order to prevent a collision with the tool magazine, in particular with a holding disk 101, on removing a tool therefrom.

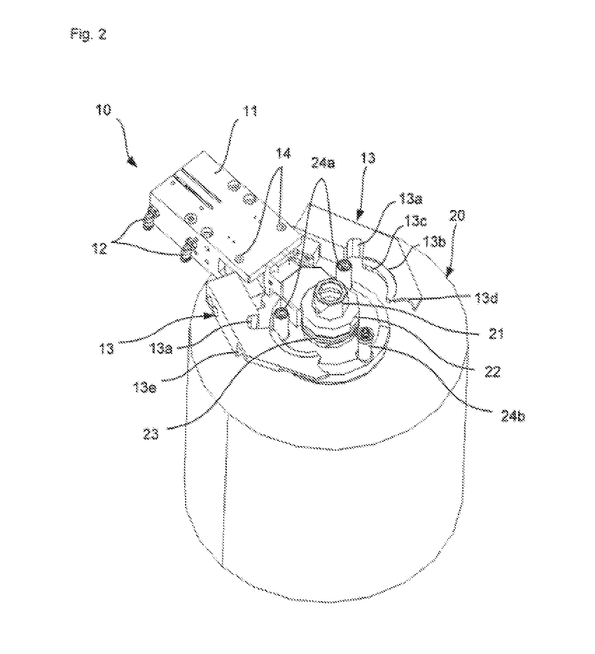

FIG. 2 shows a schematic representation of a tool 20 in addition to the gripping device 10 already described. The representation of the tool 20 is kept consciously abstract and only the holding region of the tool 20 is shown in greater detail in the figures and is described below. Purely by way of example, it can be a milling cutter, a saw tool, a drilling tool, etc. or units with a plurality of tools.

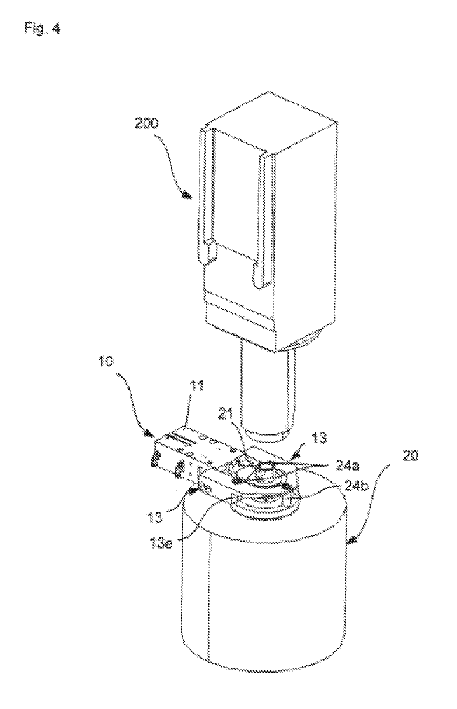

Located in the holding region of the tool 20 is the HSK taper 21 which is used for clamping the tool 20 in a machining spindle 200 (see FIG. 4). The circumference of the tool holder 22, which comprises an HSK gripper groove 23, extends adjacent to the HSK taper 21.

Support pins 24a and an entrainer pin 24b, arranged separately from each other, are provided in the holding region of the tool 20 adjacent to the HSK taper 21 or the circumference of the tool holder 22. The support and entrainer pins 24a, 24b are arranged circumferentially around the HSK holder 21 at an angle of 120° to each other.

During insertion of the tool 20 into a holder of the machining spindle 200 described later, the entrainer pin 24b is connected to said machining spindle and a medium, for example, can be transferred into the tool 20 via the support pin 24a. The entrainer pin 24b is responsible, among other things, for transferring a torque of the unit axle of the machining spindle 200 to an inner portion of the tool 20.

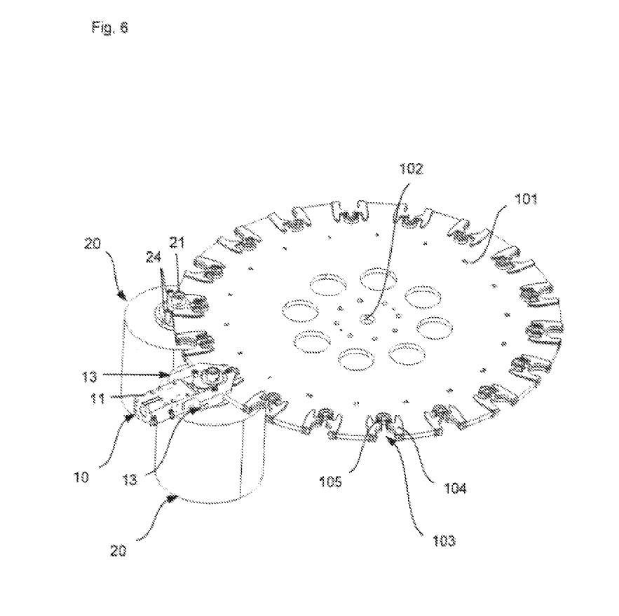

FIG. 6 is an illustration which shows a detail of a tool magazine having a holding disk 101. The holding disk 101 is rotatably supported about a vertically extending shaft which is inserted into a centrally arranged cut-out 102 of said holding disk 101.

Holders 103 are provided at equidistant angles to each other on the outer circumference of the holding disk 101, said holders each comprising tool clamps 104. Tools (cutting tools or cutting units) 20 can be inserted into each of these holders 103 and be stored there suspended. The tool clamps 104 serve as support for the HSK gripper groove 23 of the tools 20.

Purely by way of example, FIG. 6 shows two tools 20 in corresponding holders 103. Each holder 103 and the tool clamp 104 attached thereto comprises an indentation 105 directed towards the center of the holding disk 101 into which the entrainer pin 24b of a tool 20 is pushed. In this state, the support pins 24a of the tools are located outside the holder 103.

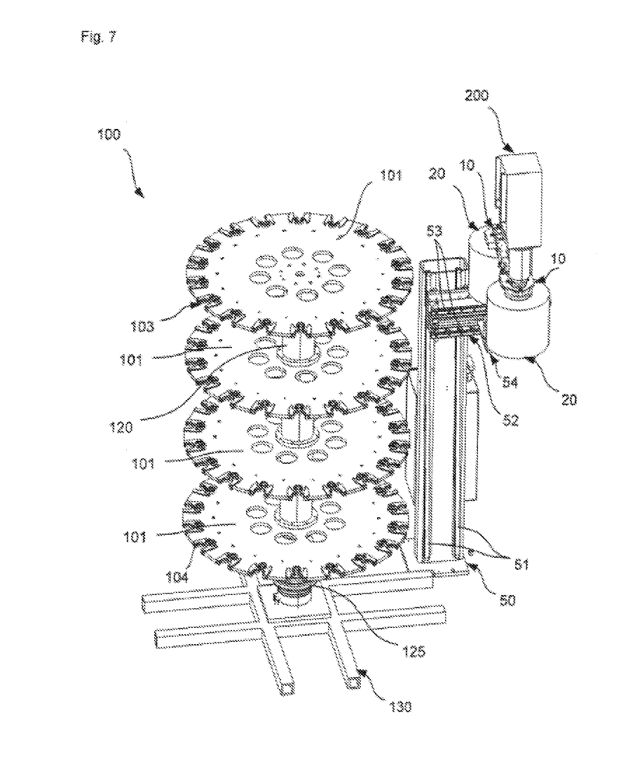

FIG. 7 shows a first embodiment of a storage system having a tool magazine 100. The tool magazine 100 comprises a plurality of holding disks 101 (in this specific example, four holding disks) which are joined together via a common support column 120. In this case, the holding disks 101 are arranged concentrically one above the other. Due to the arrangement of the holding disks 101 in a concentric manner one above the other, it is possible to provide an extremely compact type of construction which can be integrated in a machine tool.

Although the holding disks 101 can be driven via a common shaft, it is preferable according to the present invention for each holding disk 101 to be decoupled from a drive motor 125. Alternatively, each holding disk 101 can also have a separate drive. In this way it is possible to move each holding disk 101 individually. This can be used to further shorten the non-productive times.

The support column 120 of the holding disks 101 is supported relative to a stand 130 which further holds the drive motor 125.

Provided adjacent to the tool magazine 100 is a vertically aligned guide 50 which comprises a pair of parallel guide rails 51 running in the vertical direction. A first slide 52 is movable vertically up and down along the guide rails 51. The first slide 52 for its part has two guide rails 53 running horizontally, along which a second slide 54 is traversably arranged.

The second slide 54 bears a rotating mechanism 60 which can perform a pivoting movement of two gripping devices 10 about an axis running in the vertical direction. At the same time, the gripping devices 10 are aligned in different directions (in the present example, in opposing directions).

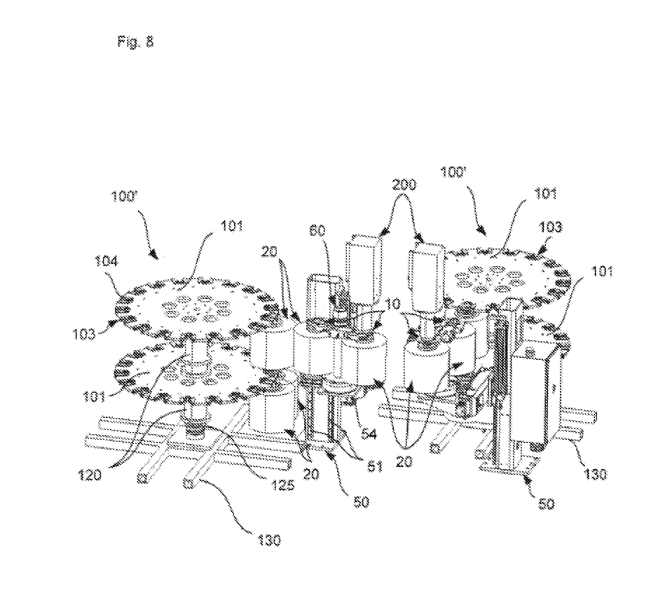

FIG. 8 illustrates a further embodiment. The embodiment illustrated in FIG. 8. differs essentially compared to the embodiment illustrated in FIG. 7 in that a plurality of magazines 100′ are provided which, in the present case, merely comprise two holding disks 101 arranged one above the other. This arrangement can be provided to load a plurality of machining spindles 200 with tools 20 in parallel.

In the embodiments illustrated in FIGS. 7 and 8, it can be seen that the tool magazines 100, 100′ are not limited to a specific number of holding disks 101 but rather two, three, four or more holding disks 101 can be provided.

Moreover, it is pointed out that a tool magazine with only one holding disk 101 can be used for the functioning of the gripping device 10, or alternatively a chain-type changer can also be used.

In the embodiments configured in FIGS. 7 and 8, two gripping devices 10, which are rotated by means of a common rotating mechanism 60, are arranged in pairs. However, it is also possible to attach only one gripping device, three gripping devices or four gripping devices to the rotating mechanism 60.

According to a further version of the embodiment described above, only one gripper jaw 13 is attached movably to the basic body 11 while a further gripper jaw 13 is fixed to the basic body 11.

In a further modification, the gripping device 10 has no pivotable gripper jaw 13. Rather, a gripping holder, which is formed similarly to a holder 103 of the previously described tool magazine 100,100′, is provided on the gripping device. According to this version, on picking up a tool 20 from the tool magazine 100, 100′, the gripping device is traversed into the vicinity of the holder 103 such that a pusher provided on said tool magazine pushes a tool 20 out of the holder 103 into the gripping holder of the gripping device. One or more protrusions (similar to the protrusion 15b) intrude during this process into the HSK gripper groove 23 in order to hold the tool 20 during the transfer to a machining spindle 200.

In a further modification of the present invention, a pusher is provided in the region of the tool magazine which pushes a tool into a gripping device in such a manner that the gripping device does not need to exert any movement to exert a force for holding the tool. Purely by way of example, spring elements can provide a force-fit connection between a circumferential surface of the tool holder 22 and the gripping device according to this version.

It can also be provided alternatively or additionally that the gripping device engages in an HSK taper 21 and thus holds or at least secures the tool during the transfer into a machining spindle. Accordingly, during the transfer, the tool can be additionally gripped in the HSK taper or an HSK taper gripper pulls the tool out of the tool clamp in the tool magazine and pushes it into a gripper clamp before the tool is picked up by the machining spindle. The HSK taper is released again when transferred into a holder of a machining spindle.

Moreover, according to a further aspect, the tool magazine can comprise a pusher which moves a tool out of a holder of the tool magazine such that the tool can be supplied directly to a machining spindle in an extended position of said pusher.

While, according to the described embodiments and modifications to the tool 20, entrainer pins 24 are provided, the gripping device 10 described here is not limited to use for tools 20 with entrainer pins 24. In addition, according to a further version, tools with only one entrainer pin can be transferred.

The changeover process for replacing a tool 20 is presented as follows.

First, a holding disk 101 of the tool magazine 100, 100′ is rotated in such a manner that a holder 103 with a corresponding tool 20, which is to be supplied to the machining spindle 200, is pivoted into a transfer position.

The first slide 52 is traversed vertically along the guide rails 51 of the guide 50 in such a manner that a gripping device 10 reaches a level of the appropriate holding disk 101.

Subsequently, the gripping device 10 is traversed along the guide rails 53 by moving the second slide 54 towards the tool 20 to be picked up.

Once the contact surface 15a of the support element 15 touches the circumference of the tool holder 22 and the protrusion 15b intrudes into the HSK gripper groove 23, the gripper jaws 13 of the gripping device 10 are closed and, on closing of the gripper jaws 13, the gripping portion 13c of said gripper jaws 13 rests on the circumference of the tool holder 22 of the tool 20. At the same time, the support pins 24a are enclosed in sections by the first cut-outs 13a and the second cut-outs 13d of the gripper jaws 13. The cut-outs 13d are used for alignment and touch the entrainer pin 24b on closing the gripping device.

Closing of the gripping device 10 by moving the gripper jaws 13 results in a combination of form-lock and force-lock once the protrusion 15b intrudes into the HSK gripper groove23 and the gripping portions 13c (and 15b) are resting on an outer circumference of the tool holder 22. The gripper jaws 13 create a force-fit connection via the gripping portions 13c.

Once the gripping device 10 has picked up the tool 20, as illustrated in FIG. 6, the second slide 54 is traversed horizontally and the tool 20 is removed from the holder 103 or pulled from the tool clamp 104 of the tool magazine 100.

By means of a subsequent pivoting movement of the rotating mechanism 60, the gripping device 10, which has just picked up the tool 20, is rotated towards a machining spindle 200 whereas the further gripping device 10 also mounted on the rotating mechanism 60 is pivoted towards the tool magazine 10. Where applicable, a tool which has just been removed from a machining spindle 200 is clamped in this further gripping device 10.

By means of a movement in the vertical direction, the tool 20 is transferred to the machining spindle 200. As the HSK taper 21 is arranged in such a manner that it extends above the gripper jaws 13 of the gripping device 10 (in other words it is exposed in the gripped state of the gripping device), the tool 20 can be clamped in the machining spindle 200 via the HSK taper 21.

Subsequently, the gripper jaws 13 are opened and the machining spindle 200 is traversed into a machining region (not illustrated) of the machine tool.

While the machining spindle 200 carries out a machining process with the inserted tool 20, the tool 20 picked up in the further gripping device 10 can be transferred to the tool magazine 100. For this, the second slide 54 is traversed towards the tool magazine 100 and the tool 20 is pushed into a holder 103. The entrainer pin 24b intrudes thereby into the indentation 105. Subsequently, the gripper jaws 13 are opened and the gripping device 10 is moved away from the tool magazine 100. The tool is suspended in the holding disk 101 in that the HSK gripper groove 23 intrudes into a corresponding portion of the tool clamp 104.

Subsequently, a new tool 20, for example, which is to be transferred to the machining spindle 200, can be selected and picked up. During the changeover, the machining spindle 200 carries out a machining process on a workpiece.

1. A gripping device for holding a tool from a tool magazine and for transferring said tool to a machining unit comprising
a basic body and a gripping mechanism joined to said basic body,
wherein the gripping mechanism is configured to create at least one force-fit connection to an outer circumference of a tool holder of the tool.

2. The gripping device according to claim 1, characterized in that the gripping mechanism comprises two gripper jaws comprising a gripping portion for gripping the outer circumference of a tool holder, wherein the gripper jaws are each pivotable relative to the basic body by a rotary axis or by a common rotary axis, or the gripper jaws can be moved towards each other in parallel.

3. The gripping device according to claim 2, characterized in that the gripper jaws are operated pneumatically.

4. The gripping device according to claim 2, characterized in that the gripper jaws further comprise a first cut-out for a support pin and/or an alignment region for a entrainer pin which is designed as a cut-out.

5. The gripping device according to claim 2, characterized in that the gripper jaws have a reduced thickness in a region of an end portion thereof.

6. The gripping device according to claim 2, wherein the gripping mechanism further comprises a support element which is fixed to the basic body or is formed integrally with the basic body, wherein said support element comprises a protrusion which is dimensioned in such that said protrusion can intrude into an HSK gripper groove of the tool.

7. The gripping device according to claim 2, wherein the gripping device is movable via a first slide in a vertical direction, and the gripping device is movable by a second slide mounted on the first slide in a horizontal direction.

8. The gripping device according to claim 2, wherein the gripping mechanism is configured to create a form-fit connection to the tool.

9. A storage system for tools, comprising a tool magazine with a plurality of levels, and at least one gripping device which is movable along a vertical guide relative to the tool magazine, wherein a tool can be held by a tool clamp of the tool magazine, and wherein the gripping device is configured to create a force-fit connection or a force-fit and form-fit connection to an outer circumference of a tool holder of the tool.

10. The storage system according to claim 9, characterized in that the levels of the tool magazine are independently movable.

11. The storage system according to claim 9, characterized in that the storage system further comprises a first slide traversable along a guide and a second slide traversable along said first slide, wherein the second slide bears the gripping device.

12. The storage system according to claim 9, characterized in that the storage system further comprises a rotary mechanism which is configured to rotate at least one gripping device about a vertical axis.

13. The storage system according to claim 9, characterized in that the storage system comprises a further plurality of tool magazines having a plurality of levels.

14. A machine tool comprises a storage system according to claim 9 and a machining unit, wherein the storage system is integrated in the machine tool.

15. A method for transferring a tool to a machining unit, comprising the steps:
force-fit or force-fit and form-fit gripping of a tool with a gripping device on an outer circumference of a tool holder of the tool,
removing the tool from a tool magazine, and transferring the tool out of the gripping device into a holder of a machining unit.

16. The gripping device according to claim 2, wherein the gripping mechanism creates a form-fit connection to the outer circumference of the tool holder of the tool.

17. The storage system of claim 9 wherein the tool magazine comprises a disk-type tool magazine with a plurality of holding disks which are independently movable.

18. The storage system of claim 17 wherein the plurality of holding disks are independently rotatable.

19. The storage system of claim 9 wherein the rotary mechanism is configured to rotate two gripping devices.
